(19) United States
(12) Patent Application Publication
(10) Pub. No.: US 2006/0002249 A1
(43) Pub. Date: Jan. 5, 2006

(54) Method for locating focus point on reflecting layer of optical disc

(75) Inventors: Jen-Yu Hsu, Hsinchu (TW); Ren-Chien Fu, Hsinchu (TW); Tun-Chieh Lee, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/167,878

(22) Filed: Jun. 27, 2005

(30) Foreign Application Priority Data
Jun. 30, 2004 (TW) 093119632

(51) Int. Cl. G11B 7/00

(52) U.S. Cl. 369/44.27; 369/44.13; 369/44.32

(57) ABSTRACT

The present invention discloses a focus control method for locating a focus point on the reflecting layer of an optical disc, particularly a blank disc without data therein. Under a primary focus condition that the focus point is close to the reflecting layer, N offset voltages are sequentially superposed onto a focus error signal to result in N corresponding counting values of a wobble signal. Select a specific offset voltage that results in the greatest counting value of the wobble signal and superpose the specific offset voltage onto the focus error signal and following focus error signals for further focus control.

### FIELD OF THE INVENTION

The present invention relates to a focus control method of an optical drive, and more particularly to a method for accurately locating a focus point on a reflecting layer of an optical disc.

### BACKGROUND OF THE INVENTION

FIG. 1 shows an optical pickup system within a pickup head of an optical drive. The optical pickup system comprises a semiconductor laser 200, a collimator lens 205, a beam splitter 210, a quarter-wave plate 220, an object lens 225, a lens 240, and a photo-detector 250. The semiconductor laser 200 emits a light beam that is transmitted through the collimator lens 205, the beam splitter 210, the quarter-wave plate 220 and the object lens 225 to an optical disc 230. The optical disc 230 reflects the light beam to the photo-detector 250 through the object lens 225, the quarter-wave plate 220, the beam splitter 210 and the lens 240.

As known, there is a reflecting layer for storing data in an optical disc. The distances between the reflecting layer and the surface of the optical disc may be different for different optical discs. For example, the distance for a DVD disc is 0.6 mm and the distance for a CD disc is 1.2 mm. Generally speaking, object lens 225 in the pickup head has a movable range for controlling the location of the focus point on the optical disc. When an optical disc is loaded into an optical drive, the object lens 225 of the pickup head has to vertically move the object lens 225 within the movable range to detect the reflecting layer. When the object lens 225 is driven to a focus position in the movable range, that means the focus point focused by the object lens 225 is projected on the reflecting layer. While the optical disc is rotating and the data on the reflecting layer is being accessed, the focus control circuit of the optical drive has to control the focus point stably located on the reflecting layer. The above-mentioned procedure is so called focusing servo process.

The signal for the optical drive to determine whether the object lens is at the focus position or not is called a focus error signal. FIGS. 2a, 2b, and 2c schematically show the light spot projected on the photo-detector when the object lens moves in the movable range. The photo-detector comprises four sensing units a, b, c, and d. The electric signals converted by the sensing units in response to respectively received light intensities are Va, Vb, Vc, and Vd. The focus error signal (FE signal) is defined as FE=(Va+Vc)−(Vb−Vd).

When the object lens is located at one end of the movable range, e.g. the distant end from the optical disc, light of small intensity is substantially equally imparted to the four sensing units. Thus, the focus error signal is zero.

When the object lens moves toward the optical disc and almost approaches the perfect focus position for accurately locating the focus point on the reflecting layer, the light spot projected on the photo-detector will have a configuration as shown in FIG. 2a. The light spot is elliptic so that the light intensities received by the four sensing units a, b, c and d differ in a manner that the received light intensities of the sensing units a and c are higher than the received light intensities of the sensing units b and d. Therefore, the focus error signal is plus.

When the object lens continuously moves and finally reaches the perfect focus position, the light spot projected on the photo-detector will be like the configuration as shown in FIG. 2b. The circular light spot renders even light intensities received by the sensing units a and c and sensing units b and d. Therefore, the focus error signal is zero.

When the object lens passes the perfect focus position just a little bit, the configuration of the light spot projected on the photo-detector will be like the one shown in FIG. 2c. The elliptic light spot with equatorial radius greater than polar radius means that the received light intensities of the sensing units b and d are higher then the received light intensities of the sensing units a and c. Therefore, the focus error signal is minus.

When the object lens further moves and reaches the other end of the movable range, e.g. the near end from the optical disc, the focus point becomes away from the reflecting layer so as to cause a small light intensity, which nevertheless, is equally projected on the four sensing units. Thus, the focus error signal is zero.

As shown in FIG. 3, it is a plot illustrating the variance of the focus error signal with the movement of the object lens between two ends of the movable range, as described above. When the object lens is driven to move between two ends of the movable range, the focus error signal would rise from zero to a plus peak value, sharply go down to the minus peak value, and then rise to zero like a lying “S” curve. Generally speaking, when the focus error signal reaches the plus peak value, it means the object lens is close to the perfect focus position and when the focus error reaches the minus peak value, it means the object lens is leaving the perfect focus position.

The focus error signal between the plus and minus peaks can be seen as a near-linear zone that is adapted for the focus control circuit to control the position of the object lens. The closed loop focus control circuit will control the movement of the object lens to keep the focus error signal in the near-linear region. That is to say, while the optical disc is rotating, the object lens is preferably controlled dynamically in order to always stay at the perfect focus position where the focus error signal is kept at zero. At the perfect focus position of the object lens, the resulting focus point will be projected on the reflecting layer so the optical drive can reproduce or record data correctly and effectively.

The above-mentioned “perfect” focus position, however, is just an ideal situation. In practice, due to inherent manufacturing error or other factors of the focus control circuit, it is difficult to make sure the current focus position resulting in zero FE signal is the real perfect focus position. In other words, even although the focus error signal is zero, the real focus point is still possibly located around the reflecting layer but not on the reflecting layer.

For solving this problem, a method of controlling a focus point on an optical disc was developed, which verifies whether the focus point is located on the reflecting layer and makes compensation when necessary.

As known, for recording data, there are a plurality of pits and lands recorded on the spiral track of the reflecting layer of an optical disc. When a laser beam is projected and focused on the track, the laser beam subsequently reflected and projected on the photo-detector can be converted into a high frequency signal (HF signal). The HF signal corresponding to the pits and the lands is then demodulated and decoded into digital data. Generally speaking, the amplitude of the HF signal is in relation with the focus condition. For example, if the focus point is located on the reflecting layer, a HF signal of larger amplitude can be obtained and the quality of the HF signal is good. On the contrary, if the focus point is not located on the reflecting layer, the amplitude is smaller and the quality of the HF signal is poor. Therefore, it is desirable to make sure the focus point is well located on the reflecting layer and make proper compensation if it is not in the prefect focus condition.

Since the conventional closed loop focus control circuit generally has difficulty in accurately locating the focus point on the reflecting layer, the focus error signal is preferably superposed with an offset voltage for modifying the focal position of the object lens. For locating a better focus position, a plurality of offset voltages are used for trial, and one of those offset voltages is selected as the most suitable one. The selection is made according to the features of the resulting high frequency (HF) signal realized by the photo-detector. In general, it is the amplitude of the HF signal serving as a criterion for determining the most suitable offset voltage for making compensation for the deviation of the focus point from the reflecting layer.

Referring to FIG. 4, it is a flowchart for illustrating such an focus control method. When a laser beam is emitted and focused on the optical disc and then reflected to and detected by the photo-detector to realize the focus error (FE) signal and the high frequency (HF) signal, a closed loop focus control circuit is used to control the focus condition according to the FE signal in order to improve the quality of the HF signal. Accordingly, a primary focus condition is obtained. The optical pickup system of FIG. 1 can be given as an example to describe the control method, and the closed loop focus control circuit controls the object lens in a manner as described in FIG. 2. In this embodiment, the movement of the object lens is made to be consistent with the near-linear zone of the focus error signal (Step 400).

Then, for possible compensation requirement, N kinds of offset voltages are sequentially superposed onto the focus error signal and thus N corresponding amplitudes of the HF signal are obtained accordingly (Step 410). The amplitudes of the HF signal are recorded and compared (Step 420). It is understood that the higher the amplitude of the HF signal, the better the quality of the HF signal is. Therefore, the HF signal with the highest amplitude is supposed to be the one obtained when the laser beam is focused on the reflecting layer. In other words, the specific offset voltage among the N kinds of offset voltages, which results in the HF signal with the highest amplitude, is a suitable one for compensation purpose to make sure the laser beam is focused on the reflecting layer (Step 430). This specific offset voltage is thus able to be used to superpose subsequent focus error signals for following data accessing procedures (Step 440).

From the above description, it is understood that in addition to the focus error signal, the prior art focus control method further refers to the high frequency signal obtained when there are data recorded in the optical disc to verify whether the focus point is well located on the reflecting layer of the optical disc. The prior art focus control method, however, cannot be applied to a blank disc without data therein. Since a blank disc does not have any pits and lands recorded on the track of the reflecting layer, it is impossible to locate the focus point by using the HF signal as described above.

### SUMMARY OF THE INVENTION

Therefore, the present invention provides a focus control method capable of verifying whether the focus point is located on the reflecting layer of a blank disc and makes compensation when necessary.

The present invention provides a focus control method, which comprises steps of: realizing a first focus error signal in response to a first laser beam reflected from an optical disc; superposing N offset voltages onto the first focus error signal to result in N corresponding counting values of a wobble signal, respectively; comparing the N corresponding counting values of the wobble signal to select a specified counting value; and superposing the first focus error signal with a specific one of the N offset voltages, which results in the wobble signal with the specified counting value, thereby obtaining a first modified focus error signal for further focus control.

In an embodiment, the focus control method further comprises steps of: realizing a second focus error signal in response to a second laser beam reflected from the optical disc; and superposing the second focus error signal with the specific one of the N offset voltages to obtain a second modified focus error signal for subsequent focus control.

Preferably, the first and second focus error signals are realized by way of closed loop focus control. In an embodiment, the optical disc is a blank disc and the second focus error signal is realized in a data recording/reproducing process.

Preferably, the specified counting values is the greatest one of the N corresponding counting values of the wobble signal.

In an embodiment, the N offset voltages are sequentially superposed onto the first focus error signal. The N corresponding counting values of the wobble signal can be obtained by sampling a decoding state of the wobble signal at a predetermined rate; defining the decoding state of the wobble signal as a first state when the wobble signal is successfully decoded and defining the decoding state of the wobble signal as a second state when the wobble signal is unsuccessfully decoded; and sequentially counting respective numbers of occurrence of the first state in response to the N offset values superposed onto the first focus error signal so as to obtain the N corresponding counting values of the wobble signal.

For example, the wobble signal can be considered successfully decoded if an absolute time in pregroove information, an address in pregroove information and/or land pre-pit information of the optical disc can be successfully realized.

In an embodiment, the first focus error signal is located within a near-linear zone between plus and minus peaks of a lying “S” curve that is outputted by a photo-detector of an optical pickup system in response to the movement of an object lens of the optical pickup system.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing an optical pickup system within a pickup head of a conventional optical drive;

FIGS. 2a, 2b, and 2c are schematic diagrams showing the light spots projected on the photo-detector and varying with the movement of the object lens in a movable range according to prior art;

FIG. 3 is a FE signal vs. distance from the focus point plot obtained by moving the object lens from one end of the movable range to the other;

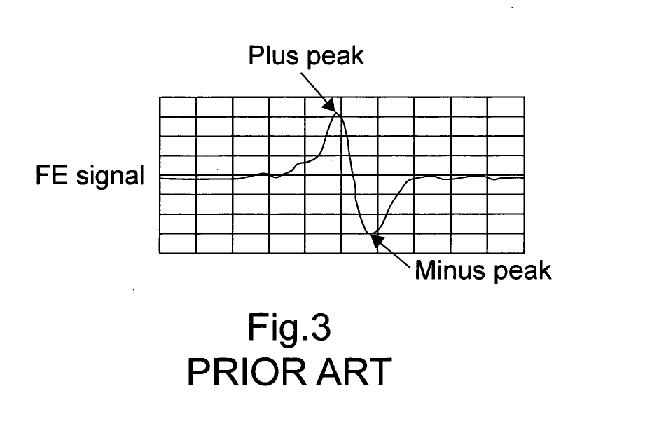

FIG. 4 shows a flowchart for illustrating a focus control method of prior art; and

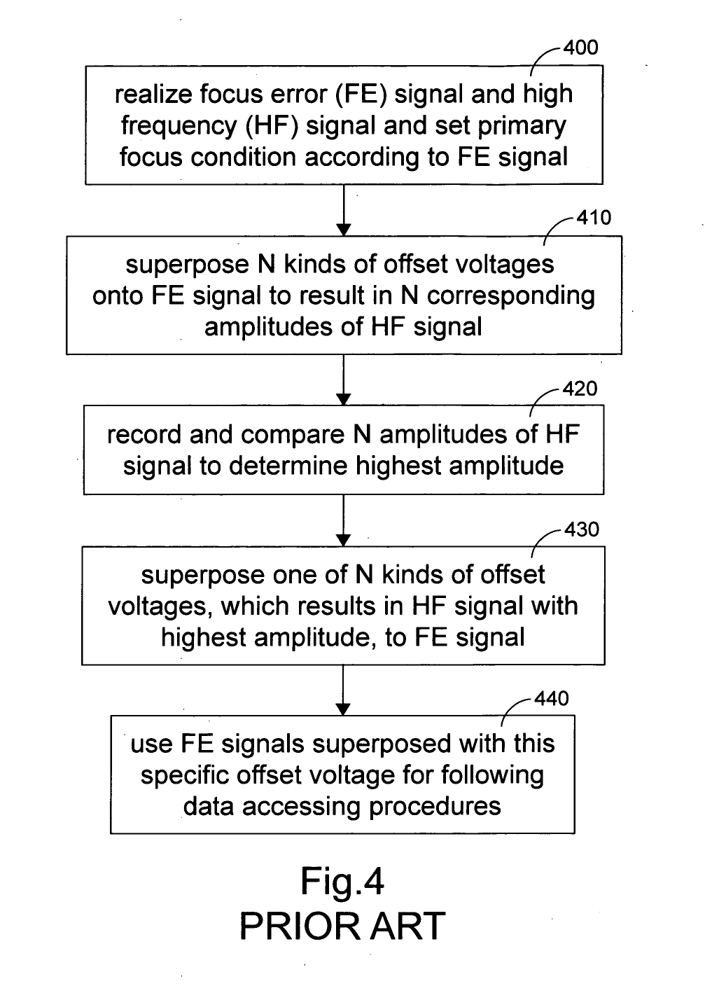

FIG. 5 shows a flowchart for illustrating an embodiment of a focus control method according to the present invention.

### DETAILED DESCRIPTION OF THE PREFERRED EMBODIMENT

The present invention can work for accurately locating a focus point on the reflecting layer of a blank disc. For each recordable disc, there is a wobble structure formed on both sides of the spiral track. The wobble structure is provided for recording absolute time in pregroove (ATIP) information in CD R/RW discs, address in pregroove (ADIP) information in DVD+R/RW discs, and both ADIP information and land pre-pit (LPP) information in DVD−R/RW discs. The optical disc drive decodes the information when recording data, and the decoded signal is referred to as a wobble signal. The wobble signal contains important information for data recording. For example, by referring to the wobble signal carried by the laser beam reflected from the optical disc to the photo-detector, the locations of pits and lands to be recorded subsequently are determined. If the wobble signal can be decoded correctly, the pits and lands can be recorded at correct locations.

In a recordable optical disc drive, there is usually a signal indicating the decoding state of the wobble signal when a recording operation is performed. For example, if the wobble signal is successfully decoded, the signal indicates a first state. On the contrary, a second state is asserted for indicating the decoding failure of the wobble signal. Generally speaking, the decoding state of the indicating signal is in relation with the focus condition. If the focus point is accurately located on the reflecting layer, it will be more frequently the first state occurs. Otherwise, the second state will occasionally or frequently occur, which means the wobble signal is likely to be decoded unsuccessfully. Accordingly, the occurrence of the wobble signal in the first state can be an indicator for determining whether the focus point is accurately located on the reflecting layer.

Since the conventional closed loop focus control circuit generally has difficulty in accurately locating the focus point on the reflecting layer, the focus error signal is preferably superposed with an offset voltage for modifying the focal position of the object lens. For locating a better focus position, the present invention uses a plurality of offset voltages for trial, and selects one from those offset voltages as the most suitable one. The selection is made according to the features of the wobble signal realized by the photo-detector. According to an embodiment of the present invention, it is the number of the occurrence of the wobble signal in the first state, which is denoted as a counting value herein, serving as a criterion for determining the most suitable offset voltage for making compensation for the deviation of the focus point from the reflecting layer.

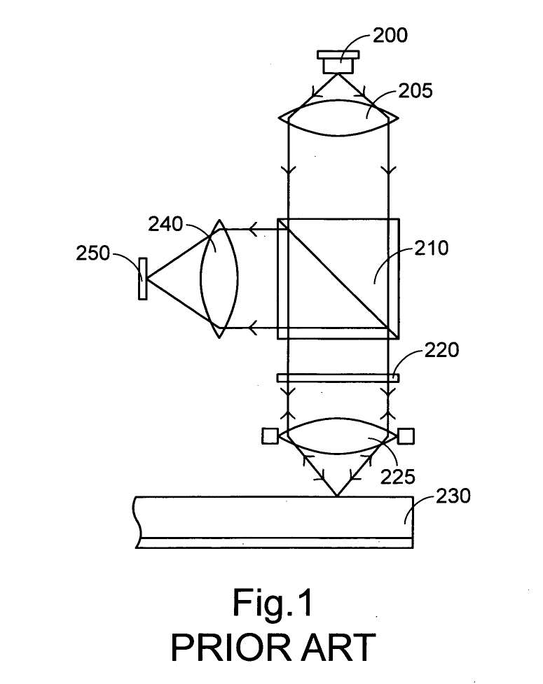

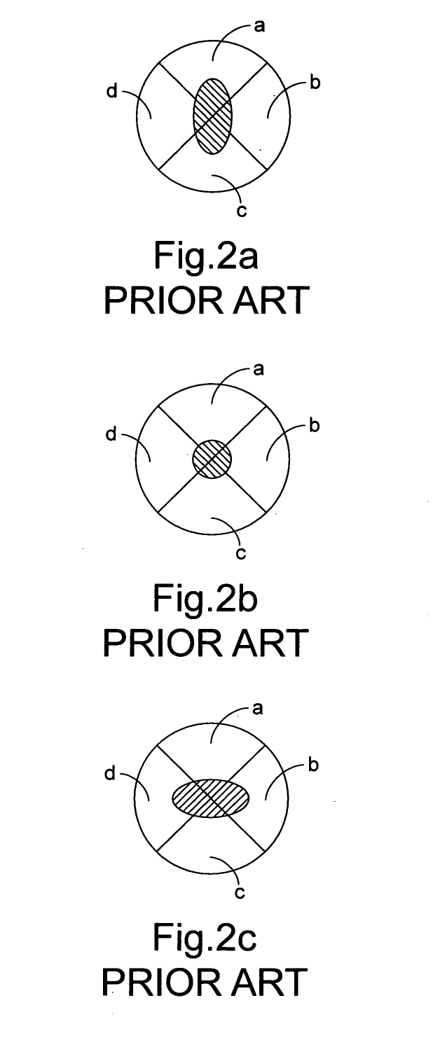

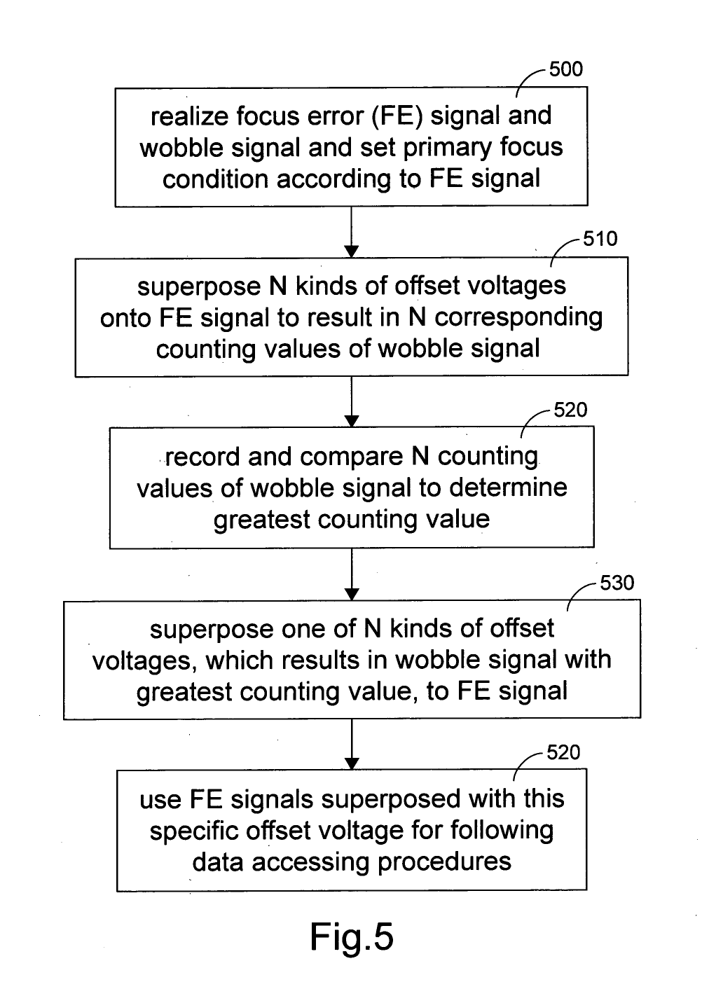

Referring to FIG. 5, it is a flowchart for illustrating an embodiment of a focus control method according to the present invention. When a laser beam is emitted and focused on the optical disc and then reflected to and detected by the photo-detector to realize the focus error signal and the wobble signal, a closed loop focus control circuit is used to control the focus condition according to the FE signal in order to correctly decode the wobble signal. Accordingly, a primary focus condition is obtained. The optical pickup system of FIG. 1 can be given as an example to describe the control method of the present invention, and the closed loop focus control circuit controls the object lens in a manner as described in FIG. 2. In this embodiment, the movement of the object lens is made to be consistent with the near-linear zone of the focus error signal (Step 500).

Then, for possible compensation requirement, N kinds of offset voltages are sequentially superposed onto the focus error signal and thus N corresponding counting values of the wobble signal are obtained accordingly (Step 510). The decoding states of the wobble signals are sampled at a preset rate to obtain a counting value. The resulting counting values for the N different offset voltages are recorded and compared (Step 520). It is understood that the greater the counting values of the wobble signal, the more chance the focus point is lying on the reflecting layer. Therefore, the wobble signal with the most frequent first-state occurrence is supposed to be the one obtained when the laser beam is focused on the reflecting layer. In other words, the specific offset voltage among the N kinds of offset voltages, which results in the wobble signal with the most frequent first-state occurrence, is a suitable one for compensation purpose to make sure the laser beam is focused on the reflecting layer (Step 530). This specific offset voltage is thus able to be used to superpose subsequent focus error signals for following data accessing procedures (Step 540).

By using the present method, the focus point can be controlled to accurately lie on the reflecting layer of a blank disc when accessing and/or reproducing/recording data. The uncertain problem of the conventional closed loop focus control circuit can be compensated with a properly selected offset voltage, thereby improving the data accessing and/or reproducing/recording quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A focus control method, comprising steps of:
realizing a first focus error signal in response to a first laser beam reflected from an optical disc;
superposing N offset voltages onto said first focus error signal to result in N corresponding counting values of a wobble signal, respectively;
comparing said N corresponding counting values of said wobble signal to select a specified counting value; and
superposing said first focus error signal with a specific one of said N offset voltages, which results in said wobble signal with said specified counting value, thereby obtaining a first modified focus error signal for further focus control.

2. The focus control method according to claim 1 further comprising steps of:
realizing a second focus error signal in response to a second laser beam reflected from the optical disc; and
superposing said second focus error signal with said specific one of said N offset voltages to obtain a second modified focus error signal for subsequent focus control.

3. The focus control method according to claim 2 wherein said first and second focus error signals are realized by way of closed loop focus control.

4. The focus control signal according to claim 2 wherein the optical disc is a blank disc and said second focus error signal is realized in a data recording/reproducing process.

5. The focus control method according to claim 1 wherein said specified counting values is the greatest one of said N corresponding counting values of said wobble signal.

6. The focus control method according to claim 1 wherein said N offset voltages are sequentially superposed onto said first focus error signal.

7. The focus control method according to claim 6 wherein said N corresponding counting values of said wobble signal are obtained by:
sampling a decoding state of said wobble signal at a predetermined rate;
defining said decoding state of said wobble signal as a first state when said wobble signal is successfully decoded and defining said decoding state of said wobble signal as a second state when said wobble signal is unsuccessfully decoded; and
sequentially counting respective numbers of occurrence of said first state in response to said N offset values superposed onto said first focus error signal so as to obtain said N corresponding counting values of said wobble signal.

8. The focus control method according to claim 7 wherein said wobble signal is successfully decoded to realize an absolute time in pregroove information.

9. The focus control method according to claim 7 wherein said wobble signal is successfully decoded to realize an address in pregroove information.

10. The focus control method according to claim 7 wherein said wobble signal is successfully decoded to realize land pre-pit information.

11. The focus control method according to claim 1 wherein said first focus error signal is located within a near-linear zone between plus and minus peaks of a lying “S” curve that is outputted by a photo-detector of an optical pickup system in response to the movement of an object lens of the optical pickup system.
